(19) United States
(12) Patent Application Publication
(10) Pub. No.: US 2026/0229473 A1
(43) Pub. Date: Aug. 6, 2026

(54) Charge state evaluation

(71) Applicant: Thermo Fisher Scientific (Bremen) GmbH, Bremen (DE)

(72) Inventors: Konstantin Ayzikov, Bremen (DE); Pedro Jose Navarro Alvarez, Bremen (DE); Bernard Delanghe, Bremen (DE)

(21) Appl. No.: 19/446,786

(22) Filed: Jan. 12, 2026

(30) Foreign Application Priority Data
Feb. 6, 2025 (GB) GB2501741.9

(51) Int. Cl. H01J 49/00; H01J 49/42

(52) U.S. Cl. CPC H01J 49/0036; H01J 49/425

(57) ABSTRACT

A method of processing mass spectral data is provided. The method comprises identifying one or more ion peaks in mass spectral data, and for each of one or more ion peaks identified in the mass spectral data: determining, from the mass spectral data, a value indicative of an intensity loss for the ion peak and evaluating a charge state for the ion peak using the intensity loss-indicative value.

### FIELD OF THE INVENTION

The present invention relates to the field of mass spectrometry, and more particularly to methods of processing mass spectral data.

### BACKGROUND

Upon completion of the Human Genome Project (Hood L. et al.; Genome Medicine; 5 (9): 79), the field of proteomics, the large-scale investigation of the (e.g. human) proteome (Anderson NL, et al.; Electrophoresis; 19 (11): 1853–1861 & Blackstock WP, et al.; Trends in Biotechnology; 17 (3): 121–127), has become a primary focus of the scientific community. Mass spectrometry (MS) based methodologies are among the most used in the field.

High throughput MS based proteomics typically involves lysis of the interrogated tissue or cell followed by enzymatic protein digestion. The resulting peptide mixture is highly complex and heterogeneous and usually requires further separation. Chromatographic separation by liquid chromatography (LC) is the most widely used separation technique prior to MS analysis (Zhang, Y., Fonslow, B. R., Shan, B., Baek, M.-C. & Yates, J. R.; Protein analysis by shotgun/bottom-up proteomics; Chem. Rev.; 113, 2343–2394 (2013)).

As part of the task of protein identification and characterisation, the spectral data obtained from LC-MS experiment(s) are typically compared to spectral data stored in databases of theoretical and/or previously acquired spectra (Sinitcyn, P., Rudolph, J. D. & Cox, J.; Computational methods for understanding mass spectrometry-based shotgun proteomics data; Annu. Rev. Biomed. Data Sci.; 1, 207–234 (2018)). The fidelity of the results as well as the computational requirements are highly bound to the quality of the experimental data, i.e. the accuracy of the LC elution time, the accuracy and precision of mass spectral parameters such as ionic m/z, and the precision and accuracy of the evaluation of charge state.

It is believed that there remains scope for improvements to methods for processing mass spectral data.

### SUMMARY

A first aspect provides a method of processing mass spectral data, the method comprising:

identifying one or more ion peaks in mass spectral data; and

for each of one or more ion peaks identified in the mass spectral data:

determining, from the mass spectral data, a value indicative of an intensity loss for the ion peak; and

evaluating a charge state for the ion peak using the intensity loss-indicative value.

Embodiments provide a method of processing mass spectral data in which one or more ions are identified in the mass spectral data, and then a charge state (e.g. singly charged, doubly charged, triply charged, etc.) for each identified ion peak is evaluated. The charge state for an ion peak is evaluated based on a value indicative of an intensity loss (an “intensity loss-indicative value”) as determined from the mass spectral data. This is in contrast with conventional methods in which ion charge state is determined solely from the m/z and intensity of ion peaks, e.g. of an isotopic cluster.

As is described in more detail below, the “intensity loss-indicative value” may be a value that is indicative of the collision cross section (CCS) (i.e. may be a “CCS-indicative value”) of ions that give rise to the ion peak. In this regard, some embodiments build on previous work (e.g., as is described in UK Patent Application GB 2,612,580, the entire contents of which is incorporated herein by reference) in which it has been shown that CCS-indicative values can be obtained directly from a mass spectrum. This contrasts with conventional methods for determining CCS values, which use dedicated ion mobility separators (e.g. drift cells, traveling-wave ion guides, trapped ion mobility separators (TIMS), and the like) to separate ions in the CCS domain. Embodiments provide a method in which the charge state for an ion peak is evaluated directly from mass spectral data obtained without ion mobility separation.

The ability to evaluate charge states of ion peaks from intensity loss-indicative values (without relying on isotopic clusters or ion mobility separation) provides an independent or complementary method for charge state determination, which can significantly increase the fidelity of the charge state determination, resulting in a reduction in false discover rates (FDR) in proteomics pipelines and a reduction of the computational load, which leads to increased throughput capacity.

It will accordingly be appreciated that embodiments provide an improved method of mass spectrometry.

A second aspect provides a method of mass spectrometry comprising:

ionising a sample to produce sample ions;

mass analysing the sample ions or ions derived from the sample ions so as to obtain mass spectral data; and

processing the mass spectral data using the method of the first aspect.

Either of the first and second aspects can, and in embodiments do, include any one or more or each of the optional features described herein.

In embodiments, a sample may be ionised, i.e. by an ion source of a mass spectrometer, to produce sample ions. The sample ions or fragment ions derived from the sample ions may be analysed by performing one or more mass analysis scan(s) so as to obtain mass spectral data, i.e. by using a mass analyser of the mass spectrometer to mass analyse the sample ions or the fragment ions. The mass analyser may be a Fourier Transform (FT) mass analyser, such an orbital trapping mass analyser (e.g. an Orbitrap^{TM} mass analyser) or an Ion Cyclotron Resonance (ICR) mass analyser, or a Time-of-Flight (ToF) mass analyser such as a Multi-Reflection Time-of-Flight (MR-ToF) mass analyser.

In some embodiments, the mass analyser is an orbital trapping mass analyser, wherein the orbital trapping mass analyser is operated with a relatively high pressure, e.g. such that the timescale for ion-gas collisions within the mass analyser is on a similar scale to the time required for a mass analysis scan. For example, an orbital trapping mass analyser is normally operated with a pressure in the region of 10⁻¹⁰ mbar or 10⁻¹¹ mbar (i.e. so as to minimise ion-gas collisions during each mass analysis scan), but in embodiments an orbital trapping mass analyser is operated with a pressure ≥10⁻⁹ mbar (e.g. between 1x10⁻⁹ and 9x10⁻⁹ mbar) when obtaining the mass spectral data (such that ion-gas collisions are significant during each mass analysis scan). As is described in UK Patent Application GB 2,612,580, operating the orbital trapping mass analyser in this pressure regime allows CCS values of ions to be estimated from the width of ion peaks in the mass spectral data.

Thus, in some embodiments, the value indicative of an intensity loss for an ion peak is a width of the ion peak (and the subsequent steps of using the intensity loss-indicative-value are performed using this width) (and the intensity loss-indicative value is indicative of a collision cross section (CCS) for the ion peak). However, it would also be possible to use other suitable values. For example, the actual collision cross section (CCS) value or some other value indicative of the collision cross section (CCS) of an ion may be determined from the width of the ion peak in the mass spectral data (and the subsequent steps of using the intensity loss-indicative-value may be performed using this value). In these embodiments, any suitable measure of ion peak width may be used, such as for example the full width at half maximum (FWHM).

These embodiments are particularly suited to embodiments where, e.g. as is described in UK Patent Application GB 2,612,580, the mass analyser is an orbital trapping mass analyser operated in a suitable pressure regime to allow CCS values of ions to be estimated from the width of ion peaks in the mass spectral data. Alternatively, the mass analyser may be an ICR mass analyser, which also exhibits the property of ion peak resolution being CCS dependent.

Other methods of determining or estimating CCS-indicative values from mass spectral data (without using ion mobility separation) may be used. For example, UK Patent Application No. GB 2,628,116, the entire contents of which are incorporated herein by reference, describes a method in which CCS-indicative values are determined using a Time-of-Flight (ToF) mass analyser. This is done by obtaining two sets of data (i.e. by performing two scans (or two sets of scans)), where one or both of (i) the ion path length and (ii) the gas pressure in the ion path is changed between the two sets of data. By comparing the intensity of corresponding ion peaks in the two sets of data, the CCS of the ions giving rise to the corresponding ion peaks can be determined.

Thus, in embodiments, the mass analyser may be a time-of-flight (ToF) mass analyser (such as a Multi-Reflection Time-of-Flight (MR-ToF) mass analyser) that is configured to determine the mass to charge ratio (m/z) of ions by determining flight times of ions along an ion path, and the step of mass analysing may comprise:

operating the mass analyser in a first mode of operation, and analysing ions by determining flight times of the ions along the ion path so as to obtain a first set of mass spectral data, wherein in the first mode of operation (i) the ion path has a first path length, and (ii) the ion path is maintained at a first pressure; and

operating the mass analyser in a second mode of operation, and analysing ions by determining flight times of the ions along the ion path so as to obtain a second set of mass spectral data, wherein in the second mode of operation (i) the ion path has a second path length, and (ii) the ion path is maintained at a second pressure, wherein the second path length is different to the first path length and/or the second pressure is different to the first pressure.

In these embodiments, the second path length may be greater than the first path length and/or the second pressure may be greater than the first pressure. In particular, the time-of-flight mass analyser may comprise one or more ion reflectors (e.g. of the various types described in GB 2,628,116), and in the first mode of operation ions may be caused to make n reflection(s) in the one or more ion reflectors, wherein n is an integer ≥ 0, and in the second mode of operation ions may be caused to make m reflection(s) in the one or more ion reflectors, wherein m is an integer > n.

In these embodiments, the step of determining, from the mass spectral data, a value indicative of an intensity loss for an ion peak may comprise: comparing an intensity of an ion peak in the first set of data to an intensity of the corresponding ion peak in the second set of data, and determining, on the basis of the comparison, a value indicative of intensity loss for the ion peak. The method may comprise: determining a ratio (or difference) of the intensity of the ion peak in the first set of data to the intensity of the corresponding ion peak in the second set of data, and determining the intensity loss-indicative value for the ion peak using the ratio (or difference). For example, in some embodiments, the value indicative of an intensity loss for the ion peak is this ratio (or difference) (and the subsequent steps of using the intensity loss-indicative-value are performed using this ratio (or difference)). Alternatively, corresponding values may be used. For example, the actual collision cross section (CCS) value may be determined from the ratio (or difference), e.g. by comparing the ratio (or difference) with a calibration to determine the CCS of the ion (and the subsequent steps of using the intensity loss-indicative-value may be performed using this CCS value).

Thus, in embodiments, the value indicative of an intensity loss for an ion peak may be a width of the ion peak or may be a ratio of (or a difference between) a first intensity for the ion peak and a second intensity for the ion peak.

In the method, a charge state for each ion peak identified in the mass spectral data is evaluated using the intensity loss-indicative value for that peak, optionally together with a mass to charge ratio (m/z) (e.g. centroid) of the ion peak. As used herein, the term “evaluating” a charge state for an ion peak can include both (i) directly determining the charge state from the intensity loss-indicative value, and (ii) checking charge state values that were determined in some other way, e.g. to filter out those ion peaks to which a charge state has been incorrectly assigned.

Thus, the step of evaluating a charge state for the ion peak may comprise at least one of:

(i) (directly) determining a charge state for the ion peak using the intensity loss-indicative value (optionally with the mass to charge ratio (m/z) of the ion peak);

(ii) determining an initial charge state for the ion peak, and using the intensity loss-indicative value (optionally with the mass to charge ratio (m/z) of the ion peak) to determine whether the initial charge state should be used as the charge state for the ion peak; and

(iii) determining two or more possible charge states for the ion peak and using the intensity loss-indicative value (optionally with the mass to charge ratio (m/z) of the ion peak) to determine which one of the two or more possible charge states should be used as the charge state for the ion peak.

In these embodiments, the step of determining an initial charge state for the ion peak or determining two or more possible charge states for the ion peak may be done using any other suitable charge state determination technique, such as for example determining the charge state from the m/z and intensity of the ion peaks of an isotopic cluster.

In step (ii), when it is determined that the initial charge state should be used as the charge state for the ion peak, then the initial charge state may be used as the charge state for the ion peak in further processing of the mass spectral data. When it is determined that the initial charge state should not be used as the charge state for the ion peak, then the ion peak may be discarded any not used for further processing, or the charge state as determined using the intensity loss-indicative value may be used as the charge state for the ion peak in further processing of the mass spectral data.

In step (iii), when it is determined that one of the two or more possible charge states should be used as the charge state for the ion peak, then that charge state may be used as the charge state for the ion peak in further processing of the mass spectral data.

In embodiments, to make the evaluation, a plurality of regions in intensity loss-indicative value-m/z space (e.g. CCS-indicative value-m/z space) are provided, with each region being associated with a particular charge state (e.g. singly charged, doubly charged, triply charged, etc.). Then, the step of evaluating a charge state for the ion peak may comprise comparing the intensity loss-indicative value for the ion peak and the mass to charge ratio (m/z) of the ion peak to the plurality of regions.

The plurality of regions may include at least a first region in intensity loss-indicative value-m/z space (e.g. CCS-indicative value-m/z space) associated with a first charge state, and a second different region in intensity loss-indicative value-m/z space (e.g. CCS-indicative value-m/z space) associated with a second different charge state. The plurality of regions may optionally include a third region associated with a third charge state in intensity loss-indicative value-m/z space (e.g. CCS-indicative value-m/z space), and so on. Then, the step of evaluating a charge state for the ion peak may comprise:

determining that the ion peak has the first charge state when the intensity loss-indicative value for the ion peak and the mass to charge ratio (m/z) of the ion peak correspond to the first region; and/or

determining that the ion peak has the second charge state when the intensity loss-indicative value for the ion peak and the mass to charge ratio (m/z) of the ion peak correspond to the second region; and/or

determining that the ion peak has the third charge state when the intensity loss-indicative value for the ion peak and the mass to charge ratio (m/z) of the ion peak correspond to the third region; and so on.

In some embodiments, each region is additionally associated with a chemical class (e.g. peptides, lipids, steroids, etc.). Then, the mass spectral data may be produced by analysing a sample having a particular chemical class, and the step of comparing the intensity loss-indicative value for the ion peak and the mass to charge ratio (m/z) of the ion peak with the plurality of regions may comprise comparing the intensity loss-indicative value for the ion peak and the mass to charge ratio (m/z) of the ion peak with only those regions associated with the particular chemical class of the sample.

Each region may be based on a “trend line” that describes a relationship between intensity loss-indicative value (or CCS) and m/z for ions having the particular charge state (and/or chemical class). For example, the first region may be based on a first trend line that describes a relationship between intensity loss-indicative value (or CCS) and m/z for ions having the first charge state, and the second region may be based on a second trend line that describes a relationship between intensity loss-indicative value (or CCS) and m/z for ions having the second different charge state. For different chemical classes (e.g. peptides, lipids, steroids, etc.) each of the different chemical classes may show different trendlines in the intensity loss- (or CCS-) indicative value-m/z space.

In this regard, there is a relationship between intensity loss- (or CCS-) indicative values and m/z for ions of various different charge state and/or chemical classes. These relationships take the form of a “trend line” in respect of each different charge state and/or chemical class. In practice, there is some spread of intensity loss- (or CCS-) indicative values for ions having a particular charge state and/or chemical class and a particular m/z, but typically this spread is sufficiently small that ions of different charge state and/or chemical classes can be distinguished in most of the intensity loss-indicative value-m/z space.

In some embodiments, the plurality of regions are provided as reference data, e.g. which may be stored in a memory accessible by the analytical instrument control system. In other words, each region may be an expected region of intensity loss-indicative value-m/z space for the particular charge state (and/or chemical class), e.g. as determined from calibration measurements.

Alternatively, the plurality of regions may be determined from the mass spectral data itself. In this regard, where the mass spectral data includes a multitude of ion peaks, by plotting or otherwise evaluating the ion peaks in intensity loss-indicative value-m/z (or CCS-indicative value-m/z) space, the distinct charge state (and/or chemical class) regions may be readily apparent. Thus, by processing the mass spectral data, e.g. by using a suitable clustering algorithm (such as k-means clustering), the plurality of regions may be determined.

Once the charge state for the ion peak has been determined, it may be used in further processing of the mass spectral data in any suitable manner. In particular, the method may further comprise using the charge state (z) for the ion peak and the mass to charge ratio (m/z) of the ion peak to determine a mass (m) for the ion peak. Then, where the mass spectral data is produced by analysing a sample, the method may further comprise using the charge state to identify one or more compounds present in the sample. For example, the method may comprise determining a charge state for each of a plurality of ion peaks identified in the mass spectral data; and submitting the charge state, the mass to charge ratio (m/z) and/or the mass (m) of each of the plurality of ion peaks to a search engine to identify one or more compounds present in the sample.

A further aspect provides a non-transitory computer readable storage medium storing computer software code which when executed on a processor performs the method described above.

A further aspect provides a control system for an analytical instrument, the control system configured to cause the analytical instrument to perform the method described above.

A further aspect provides an analytical instrument comprising the control system described above.

A further aspect provides an analytical instrument comprising:

an ion source configured to ionise a sample to produce sample ions;

a mass analyser configured to mass analyse sample ions or ions derived from sample ions so as to obtain mass spectral data; and

a control system configured to:

identify one or more ion peaks in mass spectral data; and

for each of one or more ion peaks identified in the mass spectral data:

determine, from the mass spectral data, a value indicative of an intensity loss for that ion peak; and

evaluate a charge state for the ion peak using the intensity loss-indicative value.

These aspects can, and in embodiments do, include any one or more or each of the optional features described herein.

### DESCRIPTION OF THE DRAWINGS

Various embodiments will now be described in more detail with reference to the accompanying Figures, in which:

FIG. 1 shows schematically a mass spectrometer that may be operated in accordance with embodiments;

FIG. 2 shows a plot of ionic collision cross section (CCS) as a function of mass to charge ratio (m/z);

FIG. 3(a) shows a mass spectrum of MRFA with a charge of z=2 obtained using an FTMS, and FIG. 3(b) shows a mass spectrum of MRFA with a charge of z=1 obtained using an FTMS;

FIG. 4 shows a plot of spectral FTMS resolution values of tryptic peptides;

FIG. 5 illustrates a method of mass spectrometry in accordance with embodiments;

FIG. 6 shows the plot of FIG. 4 together with an illustration of feasible regions for different charge states; and

FIG. 7 shows the plot of FIG. 4 together with an illustration of a distance R as a measure of the likelihood of an ionic charge state.

### DETAILED DESCRIPTION

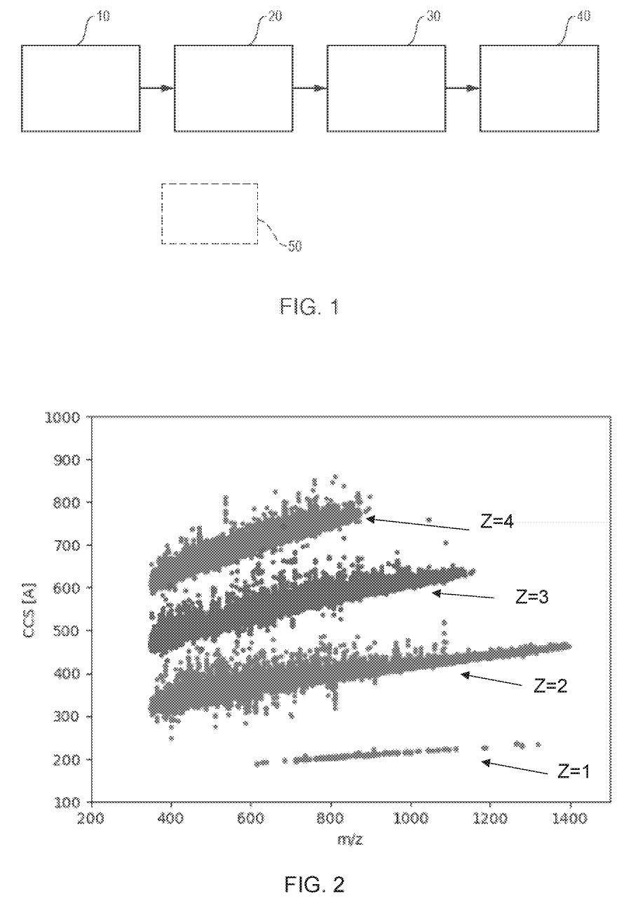

FIG. 1 illustrates schematically an analytical instrument, such as a mass spectrometer, that may be used in conjunction with the methods described herein. As shown in FIG. 1, the instrument includes an ion source 10, a mass filter 20, a fragmentation device 30, and a mass analyser 40.

The ion source 10 is configured to generate ions from a sample. The ion source 10 may be coupled to a chromatographic separation device (not shown) such as a liquid chromatography (LC) separation device, a gas chromatography (GC) separation device, or a capillary electrophoresis separation device, and the like, such that the sample which is ionised in the ion source 10 comes from the separation device. The ion source 10 can be any suitable ion source, such as an electrospray ionisation (ESI) ion source, an atmospheric pressure ionisation (API) ion source, a chemical ionisation ion source, an electron impact (EI) ion source, or similar.

The mass filter 20 is arranged downstream of the ion source 10 and is configured to receive ions from the ion source 10. The mass filter 20 is configured to filter the received ions according to their mass to charge ratio (m/z). The mass filter 20 may be configured such that received ions having m/z within an m/z transmission window (or “isolation window”) of the mass filter are onwardly transmitted by the mass filter, while received ions having m/z outside the m/z transmission window are attenuated by the mass filter, i.e. are not onwardly transmitted by the mass filter. The width and/or the centre m/z of the transmission window may be controllable (variable), e.g. by suitable control of RF and/or DC voltage(s) applied to electrodes of the mass filter 20. Thus, for example, the mass filter 20 may be operable in a transmission mode of operation, whereby most or all ions within a relatively wide m/z window are onwardly transmitted by the mass filter 20, and a filtering mode of operation, whereby only ions within a relatively narrow m/z window (centred at a desired m/z) are onwardly transmitted by the mass filter 20. The mass filter 20 can be any suitable type of mass filter, such as a quadrupole mass filter.

The fragmentation device 30 is arranged downstream of the mass filter 20 and is configured to receive most or all ions transmitted by the mass filter 20. The fragmentation device 30 may be configured to selectively fragment some or all of the received ions, i.e. so as to produce fragment ions. The fragmentation device 30 may be operable in a fragmentation mode of operation, whereby most or all received ions are fragmented so as to produce fragment ions (which may then be onwardly transmitted from the fragmentation device 30), and a non-fragmentation mode of operation, whereby most or all received ions are onwardly transmitted without being (deliberately) fragmented. It would also be possible for a non-fragmentation mode of operation to be implemented by causing ions to bypass the fragmentation device 30. The fragmentation device 30 may also be operable in one or more intermediate modes of operation, e.g. whereby the degree of fragmentation is controllable (variable). The fragmentation device 30 can also be operable in higher order (MS^{N}) fragmentation modes of operation, e.g. whereby fragment ions are further fragmented one or more times by the fragmentation device 30.

The fragmentation device 30 can be any suitable type of fragmentation device, such as for example a collision induced dissociation (CID) fragmentation device, an electron transfer dissociation (ETD) fragmentation device, an electron induced dissociation (EID) fragmentation device, a photodissociation fragmentation device, and so on. Numerous other types of fragmentation are possible.

The mass analyser 40 is arranged downstream of the fragmentation device 30 and is configured to receive ions from the fragmentation device 30. Thus, the mass analyser 40 may receive unfragmented precursor ions and/or fragment ions, depending on the mode of operation of the fragmentation device 30. The mass analyser 40 is configured to analyse the received ions so as to determine their mass to charge ratio (m/z) and/or mass, i.e. to produce a mass spectrum of the ions. The mass analyser 40 can be any suitable type of mass analyser, including a Fourier Transform (FT) mass analyser, such an orbital trapping mass analyser (e.g. an Orbitrap^{TM} mass analyser) or an Ion Cyclotron Resonance (ICR) mass analyser, and a Time-of-Flight (ToF) mass analyser such as a Multi-Reflection Time-of-Flight (MR-ToF) mass analyser.

It should be noted that FIG. 1 is merely schematic, and that the instrument can, and in embodiments does, include any number of one or more additional components. For example, the instrument may include one or more ion transfer stage(s) arranged between any of the illustrated components, e.g. including an atmospheric pressure interface and/or one or more ion guides, lenses and/or other ion optical devices configured such that some or all of the ions can be transmitted appropriately through the instrument. The ion transfer stage(s) may include any suitable number and configuration of ion optical devices, for example optionally including one or more ion guides, lenses and/or other ion optical devices.

In some embodiments, the instrument may include more than one mass analyser. For example, the instrument may be a dual mass analyser hybrid mass spectrometer of the type described in EP 3,410,463, the contents of which are incorporated herein by reference.

As also shown in FIG. 1, the instrument is under the control of a control unit 50, such as an appropriately programmed computer, which controls the operation of various components of the instrument and, for example, sets the voltages to be applied to the various components of the instrument. The control unit 50 may also receive and process data from various components including the analyser(s) in the manner of various embodiments.

The instrument may be operable in various mode of operation. In particular, the instrument may be a tandem mass spectrometer operable in an MS1 mode of operation and an MS2 mode of operation.

In the MS1 (or “full mass scan”) mode of operation, the mass filter 20 is operated in its transmission mode of operation and the fragmentation device 30 is operated in its non-fragmentation mode of operation, e.g. so that a wide m/z range (e.g. full mass range) of unfragmented (“precursor” or “parent”) ions are analysed by the analyser 40 to produce MS1 mass spectral data.

In the MS2 mode of operation, the mass filter 20 is operated in its filtering mode of operation and the fragmentation device 30 is operated in its fragmentation mode of operation, e.g. so that a selected narrow m/z range of precursor ions are fragmented and the resulting fragment (“product” or “daughter”) ions are analysed by the analyser 40 to produce MS2 mass spectral data.

The instrument may also be operable in one or more higher order fragmentation modes of operation, such as for example an MS3 mode of operation, whereby precursor ions are fragmented, at least some of the resulting fragment ions are themselves fragmented, and the second-generation fragment ions (“granddaughter ions”) are analysed by the analyser 40 produce MS3 mass spectral data. In general, the instrument may be operable in any order of fragmentation mode of operation, i.e. in an MS^{N} mode of operation where N≥2.

Typically, the first step in processing mass spectral data is the localisation of isotopic clusters and the assigning of a charge state to each cluster. There are several approaches for this evaluation, such as, e.g., the approach described in US Patent No. 11,177,121. These methods commonly rely exclusively on two primary spectral parameters, namely m/z (i.e. peak position) and the corresponding intensity. The measure of intensity can vary depending on the physics behind the mass analyser used; as an example it might be area under the peak for a beam type instrument (e.g. Time of Flight (TOF) analyser), or its height as in the Fourier Transform Mass Spectrometer (FTMS)).

A serious challenge faced by these approaches is in assigning charge states to low signal-to-noise peaks. In proteomics, such peaks are often the most interesting, as they tend to belong to functional proteins, whereas the more abundant peaks tend to belong to structural ones. Under high noise conditions, the isotopic envelope shape can be severely corrupted to the point of peaks missing, or noise peaks erroneously being assumed to belong the cluster, which inevitably leads to an incorrect charge assignment, resulting in both false positive and false negative errors for identification of the species.

Another serious challenge is encountered in dense spectra, where isotopic clusters can overlap. Under these conditions, separating overlapping peaks is difficult and error prone. Often, the failure to separate overlapping isotopic clusters results in charge misassignment causing both false positive and false negative errors for multiple species.

Errors in ionic charge state assignment not only cause erroneous (or missed) identifications, but also create an unnecessary computational overhead, which affects the speed of data processing resulting in a reduction of the overall performance of the experimental setup in terms of throughput. As laboratories are endeavouring to increase the number of samples they can process per day, it is becoming ever more important to remove any unnecessary temporal overhead.

In recent years, Ion Mobility (IM) separation coupled with MS has been steadily gaining popularity in the field of analytical sciences (Lanucara F. et al.; Nat. Chem.; 6, 281–294 (2014)). IM augments the LC/GC MS data by providing an additional analytical dimension in the form of the Collisional Cross Section (CCS). This additional measure reflects structural information of the ionic species; for example in proteomics it can give insight into the higher order structure (secondary, tertiary, and even quaternary). As higher charged species tend to exhibit a greater degree of unfolding, their CCS measure tends to be well correlated with their charge state.

FIG. 2 shows a graph of ionic CCS as a function of mass to charge ratio. The ionic species of different charges, which overlap in the m/z domain are clearly separated in CCS space. Thus, in accordance with embodiments, the knowledge of the collisional cross section in addition to mass to charge ratio can be used for charge state determination.

Embodiments provide a method, based on this understanding, that bypasses the necessity of a dedicated ion mobility device or the explicit knowledge of the CCS to determine the correct charge state of the ionic species of known m/z directly from MS spectra. The method relies on the fact that the charge states of the ionic species of the same mass can be distinctly separated without explicitly separating them via CCS values.

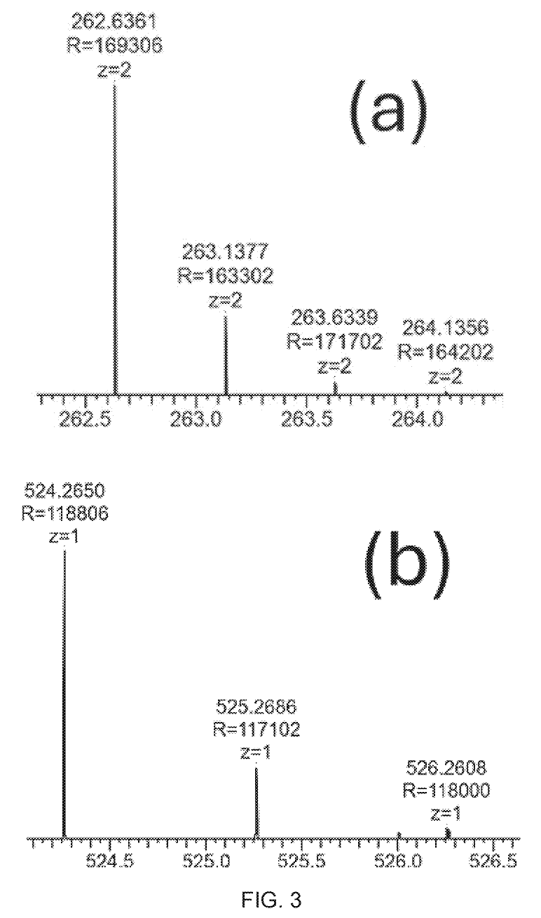

FIG. 3 shows mass spectra of the MRFA peptide for charge states z=2 (FIG. 3(a)) and z=1 (FIG. 3(b)) obtained using an FTMS. These show effective resolutions of ~169000 and ~118000, respectively. In other words, the apparent peak resolution is tied to the charge state. Furthermore, this pattern is preserved across the entire mass range of interest for a given type of compound.

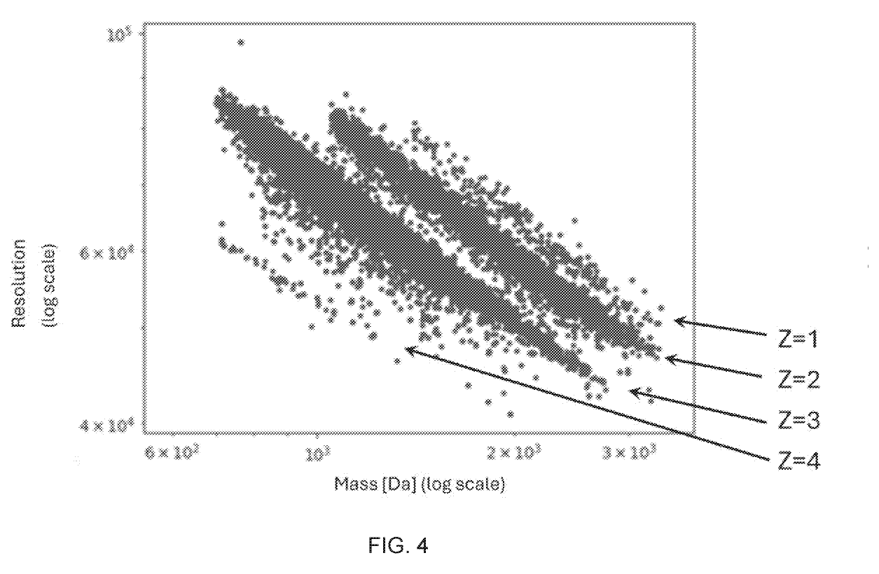

FIG. 4 shows the distribution of spectral peak resolution values of tryptic peptides as function of their mass for FTMS data. The clear separation of the charge states into distinct regions allows for quick and unambiguous charge state determination and/or filtering of any erroneously assigned values.

In some embodiments, CCS values are measured based on the mass measurement step in an Orbitrap^{TM} mass analyser. At elevated UHV pressures (e.g. around 10⁻⁹ mbar) in the Orbitrap^{TM} mass analyser, the ion’s decay in the transient domain is tied to its CCS value. For ensemble measurements, the decay rate of an individual ion species, i.e. an ion of a certain m/z and charge state, results in a change in the observed mass resolution (i.e. peak width) of that ion in the mass spectrum. In order to measure CCS values in the Orbitrap^{TM} mass analyser, the UHV is increased to where the ions start to show appreciable decay on the timescale of the transient acquisition (e.g. around 10⁻⁹ mbar). The result of this decay is demonstrated in the observed mass resolution.

In other embodiments, CCS-indicative values are instead determined from the mass spectral data using the method described in UK Patent Application No. GB 2,628,116. In this method, CCS-indicative values are determined using a Time-of-Flight (ToF) mass analyser, where two sets of data are obtained (i.e. by performing two scans (or two sets of scans)), where one or both of (i) the ion path length and (ii) the gas pressure in the ion path is changed between the two sets of data. By comparing the intensity of corresponding ion peaks in the two sets of data, the CCS of the ions giving rise to the corresponding ion peaks can be determined.

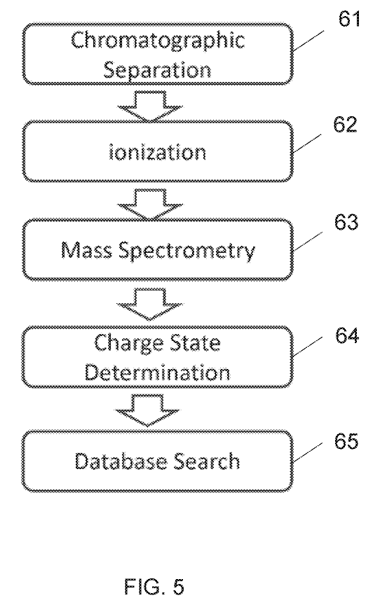

FIG. 5 illustrates steps taken in a typical high-throughput LC-IM-MS experiment after the sample preparation phase. Since the biological samples are intrinsically dense, chromatography is employed to separate the mixture into sparser components (step 61). Once the sample is chromatographically separated it is ionised (step 62) and introduced into a mass spectrometer for MS analysis (step 63). Once mass spectra are acquired the charge states are evaluated (step 64), and the data is submitted for a database search (step 65) to attempt to identify compounds present in the sample.

In embodiments, the charge state determination (step 64) is done based temporal signal decay containing information, e.g. calculated transient decay and/or resolution in FTMS, or number of passes dependent intensity loss as in multi-pass TOF system (as described above). This is in contrast with existing methods for charge state determination, which rely solely on the data deconvolution of the isotopic distributions.

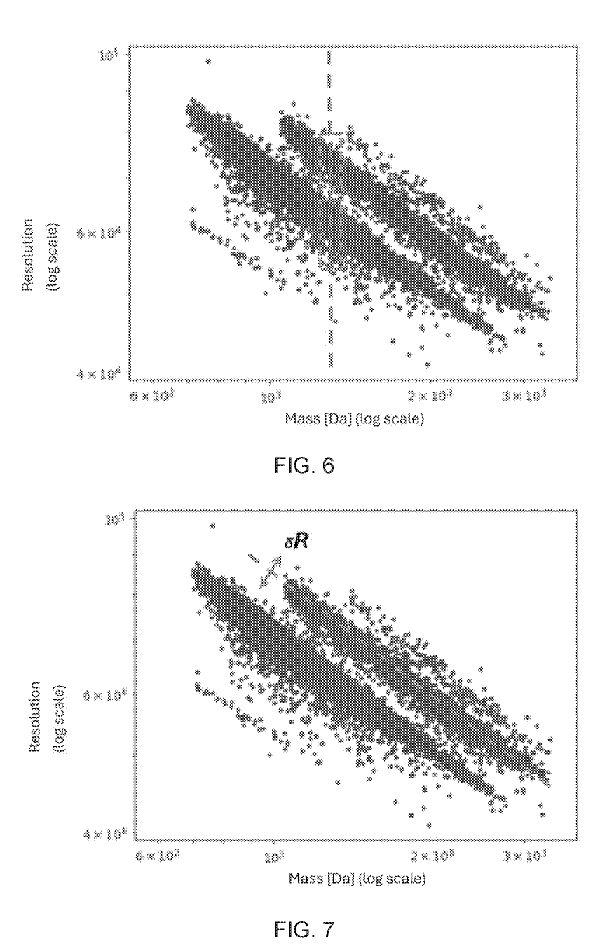

In some embodiments, the MS resolution is used to impose a strict limit on the charge state an ion of a specific mass can actually have. This is illustrated by FIG. 6, which shows the feasible regions for different charge states. This dependency can be specific to the chemical nature of the analyte, e.g. peptides, lipids, steroids, etc. Therefore resolution versus mass trends for different types of compounds may be evaluated (or calibrated) beforehand.

In some cases, such as in the case of peptides, the regions that define charge state for given masses are well defined and non-overlapping. However, for cases where the boundaries are less well-defined, the method may use a measure of the resolution distance δR to the expected trend in the m/z versus CCS space to assign the most likely charge state. This is illustrated by FIG. 7, which shows the distance δR as a measure of the likelihood of the ionic charge state.

In some embodiments, δR can also be used to improve the fidelity of the charge state assignments by other charge state determination methods (that rely on mass spectral data only), e.g. by adding weights to the potential charge state values. This may be useful when all other criteria for the charge state determination are not conclusive.

Finally, in some embodiments, the δR values can be used as filters prior to the database search to reduce the false discovery rate and reduce the computational load. For example, if a candidate species of a specific mass (m) and charge (z) demonstrates inconsistency with the expected resolution based on the predefined regions in the resolution versus mass space, or in terms of the δR, it can be marked as a false and can be excluded from the search.

It will be appreciated that embodiments provide methods of using CCS measures, such as FTMS spectral peak resolution, in charge state determination in MS based studies. This provides a significant increase in the fidelity of the charge state determination, resulting in a decrease in the false discovery rate in proteomics pipelines as well as a reduction of the computational load on the bioinformatics platforms, which leads to increased throughput capacity.

Although the present invention has been described with reference to various embodiments, it will be understood that various changes may be made without departing from the scope of the invention as set out in the accompanying claims.

1. A method of processing mass spectral data, the method comprising:
identifying one or more ion peaks in mass spectral data; and
for each of one or more ion peaks identified in the mass spectral data:
determining, from the mass spectral data, a value indicative of an intensity loss for the ion peak; and
evaluating a charge state for the ion peak using the intensity loss-indicative value.

2. The method of claim 1, wherein the step of evaluating a charge state for the ion peak comprises evaluating a charge state for the ion peak using the intensity loss-indicative value and a mass to charge ratio (m/z) of the ion peak.

3. The method of claim 2, wherein the step of evaluating a charge state for the ion peak comprises at least one of:
(i) directly determining a charge state for the ion peak using the intensity loss-indicative value and the mass to charge ratio (m/z) of the ion peak;
(ii) determining an initial charge state for the ion peak, and using the intensity loss-indicative value and the mass to charge ratio (m/z) of the ion peak to determine whether the initial charge state should be used as the charge state for the ion peak; and
(iii) determining two or more possible charge states for the ion peak, and using the intensity loss-indicative value and the mass to charge ratio (m/z) of the ion peak to determine which one of the two or more possible charge states should be used as the charge state for the ion peak.

4. The method of claim 1, wherein the intensity loss-indicative value is indicative of a collision cross section (CCS) for the ion peak.

5. The method of claim 1, wherein:
a plurality of regions in intensity loss-indicative value-m/z space are provided, with each region being associated with a particular charge state; and
the step of evaluating a charge state for the ion peak comprises comparing the intensity loss-indicative value for the ion peak and the mass to charge ratio (m/z) of the ion peak with the plurality of regions.

6. The method of claim 5, wherein the plurality of regions are provided as reference data, or wherein the plurality of regions are determined from the mass spectral data.

7. The method of claim 5, wherein:
each region is associated with a chemical class;
the mass spectral data is produced by analysing a sample having a particular chemical class; and
the step of comparing the intensity loss-indicative value for the ion peak and the mass to charge ratio (m/z) of the ion peak with the plurality of regions comprises comparing the intensity loss-indicative value for the ion peak and the mass to charge ratio (m/z) of the ion peak with the regions associated with the particular chemical class of the sample.

8. The method of claim 5, wherein the plurality of regions include at least a first region associated with a first charge state, and a second different region associated with a second different charge state.

9. The method of claim 8, wherein the step of evaluating a charge state for the ion peak comprises:
determining that the ion peak has the first charge state when the intensity loss-indicative value for the ion peak and the mass to charge ratio (m/z) of the ion peak correspond to the first region; and/or
determining that the ion peak has the second charge state when the intensity loss-indicative value for the ion peak and the mass to charge ratio (m/z) of the ion peak correspond to the second region.

10. The method of claim 8, wherein the first region is based on a first trend line that describes a relationship between CCS and m/z for ions having the first charge state and the second region is based on a second trend line that describes a relationship between CCS and m/z for ions having the second different charge state.

11. The method of claim 1, further comprising using the charge state (z) for the ion peak and the mass to charge ratio (m/z) of the ion peak to determine a mass (m) for the ion peak.

12. The method of claim 1, wherein the mass spectral data is produced by analysing a sample, and the method further comprises using the charge state to identify one or more compounds present in the sample.

13. The method of claim 12, further comprising:
determining a charge state for each of a plurality of ion peaks identified in the mass spectral data; and
submitting the charge state, the mass to charge ratio (m/z) and/or the mass (m) of each of the plurality of ion peaks to a search engine to identify one or more compounds present in the sample.

14. The method of claim 1, wherein:
the value indicative of an intensity loss for an ion peak is a width of the ion peak; or
the value indicative of an intensity loss for an ion peak is a ratio of or a difference between a first intensity for the ion peak and a second intensity for the ion peak.

15. A method of mass spectrometry comprising:
ionising a sample to produce sample ions;
mass analysing the sample ions or ions derived from the sample ions so as to obtain mass spectral data; and
processing the mass spectral data, wherein processing the mass spectral data comprises:
identifying one or more ion peaks in mass spectral data; and
for each of one or more ion peaks identified in the mass spectral data:
determining, from the mass spectral data, a value indicative of an intensity loss for the ion peak; and
evaluating a charge state for the ion peak using the intensity loss-indicative value.

16. The method of claim 15, wherein:
the step of mass analysing comprises using a Fourier transform (FT) mass analyser to mass analyse the sample ions or ions derived from the sample ions; and
the value indicative of an intensity loss for an ion peak is a width of the ion peak.

17. The method of claim 16, wherein the Fourier transform (FT) mass analyser is an orbital trapping mass analyser operated with a pressure ≥ 10⁻⁹ mbar.

18. The method of claim 15, wherein:
the step of mass analysing comprises: using a time-of-flight (ToF) mass analyser to mass analyse the sample ions or ions derived from the sample ions, wherein the time-of-flight (ToF) mass analyser is configured to determine the mass to charge ratio (m/z) of ions by determining flight times of ions along an ion path;
the step of using a time-of-flight (ToF) mass analyser to mass analyse sample ions or ions derived from the sample ions comprises:
operating the mass analyser in a first mode of operation, and analysing ions by determining flight times of the ions along the ion path so as to obtain a first set of mass spectral data, wherein in the first mode of operation (i) the ion path has a first path length, and (ii) the ion path is maintained at a first pressure; and
operating the mass analyser in a second mode of operation, and analysing ions by determining flight times of the ions along the ion path so as to obtain a second set of mass spectral data, wherein in the second mode of operation (i) the ion path has a second path length, and (ii) the ion path is maintained at a second pressure, wherein the second path length is different to the first path length and/or the second pressure is different to the first pressure; and
the step of determining, from the mass spectral data, a value indicative of an intensity loss for an ion peak comprises:
comparing an intensity of an ion peak in the first set of data to an intensity of a corresponding ion peak in the second set of data; and
determining, on the basis of the comparison, a value indicative of intensity loss for the ion peak.

19. A non-transitory computer readable storage medium storing computer software code which when executed on a processor performs the method of claim 18.

20. An analytical instrument comprising:
an ion source configured to ionise a sample to produce sample ions;
a mass analyser configured to mass analyse sample ions or ions derived from sample ions so as to obtain mass spectral data; and
a control system configured to:
identify one or more ion peaks in mass spectral data; and
for each of one or more ion peaks identified in the mass spectral data:
determine, from the mass spectral data, a value indicative of an intensity loss for that ion peak; and
evaluate a charge state for the ion peak using the intensity loss-indicative value.
